(19) United States
(12) Patent Application Publication
(10) Pub. No.: US 2024/0384140 A1
(43) Pub. Date: Nov. 21, 2024

(54) ADHESIVE COMPOSITIONS AND SEAMS AND FILMS FORMED THEREFROM

(71) Applicant: Avient Corporation, Avon Lake, OH (US)

(72) Inventors: Ketan Shah, Gurnee, IL (US); Cesar Cruz, Woodstock, IL (US)

(73) Assignee: Avient Corporation, Avon Lake, OH (US)

(21) Appl. No.: 18/666,395

(22) Filed: May 16, 2024

Related U.S. Application Data
(60) Provisional application No. 63/466,998, filed on May 16, 2023.

(51) Int. Cl. C09J 109/06; C09J 5/06; C09J 11/08

(52) U.S. Cl. CPC C09J 109/06; C09J 5/06; C09J 11/08; C09J 2400/263; C09J 2409/00

(57) ABSTRACT

An adhesive composition includes, based on a total weight of the adhesive composition, 18 wt % to 30 wt % of a styrene-ethylene/butylene-styrene triblock copolymer, 6 wt % to 30 wt % of a tackifier, 30 wt % to 50 wt % of a white mineral oil, and 5 wt % to 35 wt % of an incompatible polymer composition. The styrene-ethylene/butylene-styrene triblock copolymer has a weight average molecular weight of 90,000 g/mol to 140,000 g/mol. The tackifier has a weight average molecular weight of 500 g/mol to 5000 g/mol, a glass transition temperature of 50° C. to 100° C., and a softening temperature of 100° C. to 140° C. The incompatible polymer composition includes at least two of a high density polyethylene, a crosslinked ethylene-propylene-diene rubber, and an olefin block copolymer.

### CLAIM OF PRIORITY

This application claims the benefit of U.S. Provisional Patent Application Ser. No. 63/466,998 bearing Attorney Docket Number 1202307 and filed on May 16, 2023, which is hereby incorporated by reference in its entirety.

### TECHNICAL FIELD

Embodiments of the present disclosure are generally related to adhesive compositions. More particularly, adhesive compositions include a styrene-ethylene/butylene-styrene triblock copolymer, a tackifier, a white mineral oil, and an incompatible polymer composition comprising at least two of a high density polyethylene, a crosslinked ethylene-propylene-diene rubber, and an olefin block copolymer.

### BACKGROUND

Thermoplastic polyurethane compositions are commonly used in the apparel industry, such as in seamless elastic tapes, due to their desirable chemical resistance (e.g., resistance to lotions, deodorants, antiperspirants, oils, fragrances, sweat, etc.) and heat resistance (e.g., durability when subjected to multiple wash cycles). However, the use of thermoplastic polyurethane compositions may be cost prohibitive.

Accordingly, a need exists for cost-effective thermoplastic compositions having similar or improved chemical resistance and heat resistance as compared to conventional thermoplastic polyurethane compositions.

### SUMMARY

Embodiments of the present disclosure are directed to adhesive compositions.

According to some embodiments, an adhesive composition is provided. The adhesive composition includes, based on a total weight of the adhesive composition, 18 wt % to 30 wt % of a styrene-ethylene/butylene-styrene triblock copolymer, 6 wt % to 30 wt % of a tackifier, 30 wt % to 50 wt % of a white mineral oil, and 5 wt % to 35 wt % of an incompatible polymer composition. The styrene-ethylene/butylene-styrene triblock copolymer has a weight average molecular weight of 90,000 g/mol to 140,000 g/mol. The tackifier has a weight average molecular weight of 500 g/mol to 5000 g/mol, a glass transition temperature of 50° C. to 100° C., and a softening temperature of 100° C. to 140° C. The incompatible polymer composition includes at least two of a high density polyethylene, a crosslinked ethylene-propylene-diene rubber, and an olefin block copolymer.

According to some embodiments, a method of forming a film is provided. The method includes preparing an adhesive film composition and extruding the adhesive film composition to form a film that has a thickness of 25 μm to 350 μm. The adhesive film composition includes, based on a total weight of the adhesive film composition, 18 wt % to 30 wt % of a styrene-ethylene/butylene-styrene triblock copolymer, 6 wt % to 30 wt % of a tackifier, 30 wt % to 50 wt % of a white mineral oil, and 5 wt % to 35 wt % of an incompatible polymer composition. The styrene-ethylene/butylene-styrene triblock copolymer has a weight average molecular weight of 90,000 g/mol to 140,000 g/mol. The tackifier has a weight average molecular weight of 500 g/mol to 5000 g/mol, a glass transition temperature of 50° C. to 100° C., and a softening temperature of 100° C. to 140° C. The incompatible polymer composition includes at least two of a high density polyethylene, a crosslinked ethylene-propylene-diene rubber, and an olefin block copolymer.

According to other embodiments, a method of preparing a seam is provided. The method includes supplying a first section of fabric, a second section of fabric, and an adhesive layer; situating the adhesive layer between the first section of fabric and the second section of fabric to form a seam section; and heating the seam section such that the adhesive layer adheres the first section of fabric and the second section of fabric. The second section of fabric at least partially overlaps the first section of fabric. The adhesive layer includes an adhesive composition. The adhesive composition includes, based on a total weight of the adhesive composition, 18 wt % to 30 wt % of a styrene-ethylene/butylene-styrene triblock copolymer, 6 wt % to 30 wt % of a tackifier, 30 wt % to 50 wt % of a white mineral oil, and 5 wt % to 35 wt % of an incompatible polymer composition. The styrene-ethylene/butylene-styrene triblock copolymer has a weight average molecular weight of 90,000 g/mol to 140,000 g/mol. The tackifier has a weight average molecular weight of 500 g/mol to 5000 g/mol, a glass transition temperature of 50° C. to 100° C., and a softening temperature of 100° C. to 140° C. The incompatible polymer composition includes at least two of a high density polyethylene, a crosslinked ethylene-propylene-diene rubber, and an olefin block copolymer.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DRAWINGS

FIG. 1 depicts an exemplary adhesive film, according to one or more embodiments shown and described herein;

FIG. 2 depicts an exemplary multilayer composite, according to one or more embodiments shown and described herein;

FIG. 3 depicts an exemplary multilayer composite with an adhesive film adhered to a fabric backing, according to one or more embodiments shown and described herein;

FIG. 4 depicts an exemplary multilayer composite comprising an adhesive film adhered to a release liner, according to one or more embodiments shown and described herein;

FIG. 5 depicts an exemplary adhesive webbing, according to one or more embodiments shown and described herein

FIG. 6 depicts an exemplary seam, according to one or more embodiments shown and described herein;

FIG. 7 depicts another exemplary seam, according to one or more embodiments shown and described herein; and

FIG. 8 depicts an exemplary seam with stiches, according to one or more embodiments shown and described herein.

### DETAILED DESCRIPTION

Reference will now be made in detail to various embodiments of adhesive compositions and seams and films formed therefrom.

The disclosure should not be construed as limited to the embodiments set forth herein. Rather, these embodiments are provided so that this disclosure will be thorough and complete, and will fully convey the subject matter to those skilled in the art.

### Definitions

Unless otherwise expressly defined, all technical and scientific terms used herein have the same meaning as commonly understood by a person of ordinary skill in the art. The terminology used in the disclosure herein is for describing particular embodiments only and is not intended to be limiting.

Unless otherwise expressly stated, it not intended that any method disclosed herein be construed as requiring that its steps be performed in a specific order, nor that any article set forth herein be construed as requiring specific orders or orientations to its individual components.

Unless otherwise expressly stated, it is intended that any composition or mixture disclosed herein may comprise, consist essentially of, or consist of the disclosed components.

As used herein, the singular form of a term is intended to include the plural form of the term, unless the context clearly indicates otherwise.

As used herein, numerical values are not strictly limited to the exact numerical value recited. Instead, unless otherwise expressly stated, each numerical value is intended to mean both the exact numerical value and “about” the numerical value, which encompasses a functionally equivalent range surrounding that numerical value, such that either possibility is contemplated as an embodiment disclosed herein.

As used herein, the term “chemical resistance” refers to the ability of a material to withstand exposure to a chemical substance. For example, the chemical substance may be lotions, deodorants, antiperspirants, oils, fragrances, sweat, or combinations thereof.

As used herein, the term “heat resistance” refers to the ability of a material to be able to resist or be unaffected by heat.

The adhesive compositions described herein have similar or improved chemical resistance and heat resistance as compared to conventional thermoplastic polyurethane compositions. This is exemplified in the examples provided herein, where a comparative adhesive film and example adhesive films as disclosed herein were bonded to fabric, subjected to various wash and deodorant conditions, and then subjected to a peel force test.

As used herein, the terms “adhesion” or “bonding strength” refer to the ability of a material to adhere to another material, as determine by peel force.

As used herein, the term “peel force” refers to the force required to separate two layers of fabric from an adhesive film, which is situated between the two layers of fabric and bonded at 160° C. under 35 kPa for 15 seconds as measured by an Instron tensile tester. The two ends of the fabric layers are mounted on the Instron tensile tested and pulled apart at 2 inches per minute to separate the two layers of fabric from the adhesive film. Peel force is provided in Newtons per linear meter (i.e., N/m).

As used herein, the term “elasticity” refers to the stretchiness of a material, as determined by measuring the load at 200% using the two cycle 200% stretch test.

As used herein, the term “elastic recovery” refers to the ability of a material to return to

its original shape when a load is removed, as determined by measuring hysteresis using the two cycle 200% stretch test.

As used herein, the term “two cycle 200% stretch test” refers to the following process. In a first cycle, a 1 inch long and 1 inch wide film is mounted in the jaws of an Instron tensile tester and pulled to 200% extension at a rate of 10 inches/minute. The film is then held at that extension for 2 minutes. After the 2 minutes, the Instron returns the film to its original length of 2 inches and holds the film in that position for one minute. In a second cycle, the film is again pulled to 200% extension at a rate of 10 inches/minute. The film is then held at that extension for 2 minutes and the load on the film is measured (i.e., load at 200%). After the 2 minutes, the Instron returns the film to its original length of 2 inches and holds the film in that position for one minute. After the second cycle, the hysteresis is measured by determining the length of the deformed film and calculating the percent difference between the original 2 inch length and the deformed length. For example, if, after two cycles, the film becomes 2.4 inches long due to permanent deformation, then it is considered to have 20% hysteresis.

As used herein, the term “surface tack” refers to the strength at which an adhesive film can stick to itself.

As used herein, the term “hardness” refers to a measure of the resistance a material has to indentation, as measured as measured according to ASTM D2240.

As used herein, the term “polydispersity” refers to a molecular weight distribution metric measured as the weight average molecular weight (MW) divided by the number average molecular weight (MN).

As used herein, the term “weight average molecular weight” refers to the weighted sum of all the molecular weights in the population, where the weighting factor is the mole fraction of each molecule sum of the weight of all chains in the polymer divided by the total number of chains, as measured according to Gel Permeation Chromatography (GPC) using polystyrene standards.

As used herein, the term “number average molecular weight” refers to the statistical average molecular weight of all polymer chains in the sample and is the sum of the weight of all chains in the polymer divided by the total number of chains, as measured according to Gel Permeation Chromatography (GPC) and Size Exclusion Chromatography (SEC) using polystyrene standards. As used herein, the term “glass transition temperature” refers to the temperature at which an amorphous polymer changes from a hard/glassy state to a soft/leathery state, or vice versa.

As used herein, the term “softening temperature” refers to the temperature at which a polymer flows under a load on heating.

As used herein, the term “film” refers to a thin continuous material having a thickness less than or equal to 350 μm thick.

As used herein, the term “high density polyethylene” refers to a polyethylene having a density of 0.93 grams per cubic centimeter (g/cc) or greater.

As used herein the term “olefin block copolymer” refers to a polyolefin elastomer that comprises alternating block of rigid and elastic segments.

As used herein, the term “melt flow rate” refers to a measure of ease of flow of a melted material through an orifice at a specified temperature and load, as measured according to ASTM D1238. The term “melt flow index” also may be used to refer to melt flow rate.

As used herein, the term “formed from” (including related terms such as “forming”) refers to, with respect to an article (or component of an article) and an adhesive composition, that the article (or component of the article) is extruded, molded, shaped, pressed, or otherwise made, in whole or in part, from the adhesive composition under sufficient heating to enable such forming. As such, the term “formed from” (including related terms such as “forming”) means, in some embodiments, the article (or component of an article) can comprise, consist essentially of, or consist of, the adhesive composition; and, in other embodiments, the article (or component of an article) consists of the adhesive composition because the article (or component of an article) is, for example, made by an extrusion process or a molding process.

### Usefulness

As discussed hereinabove, thermoplastic polyurethane compositions are commonly used in the apparel industry, such as in seamless elastic tapes, due to their desirable chemical resistance (e.g., resistance to lotions, deodorants, antiperspirants, oils, fragrances, sweat, etc.) and heat resistance (e.g., durability when subjected to multiple wash cycles). However, the use of thermoplastic polyurethane compositions may be cost prohibitive.

Disclosed herein are adhesive compositions. Specifically, the adhesive compositions disclosed herein include a styrene-ethylene/butylene-styrene triblock copolymer, a tackifier, a white mineral oil, and an incompatible polymer composition comprising at least two of a high density polyethylene, a crosslinked ethylene-propylene-diene rubber, and an olefin block copolymer.

Advantageously, the styrene-ethylene/butylene-styrene triblock copolymer, tackifier, mineral oil and incompatible polymer composition help to achieve an adhesive composition that has similar or improved chemical resistance and heat resistance as compared to conventional thermoplastic polyurethane compositions. In particular, the incompatible polymer composition is chemically incompatible with the rubber matrix (i.e., SEBS) from the stand point of its elastic/mechanical properties create a morphology in the adhesive composition (i.e. create an internal structure), which may be in the form of discreet domains with or without intertwined fabric filaments. The formation of the morphology depends on the rheology of each component in the formulation at the processing temperature in combination with imposed shear forces. The morphology will result in a tortuous path for any chemical that is introduced to the overall composition and improve chemical resistance. If the incompatible polymer is used in small amount, it would be so chosen that it would serve the purpose of a filler in the matrix, and it would also be chemically not miscible (compatible) with the rubber matrix. This polymer component will provide chemical resistance to foreign molecules such as sweat, de-odorants, perfume etc, and also provide heat resistance. On the other hand, if the incompatible polymer component is used in large amount, then the incompatible components will be so chosen that their elastic/mechanical properties are similar to the rubber matrix, but chemically they are still immiscible (incompatible) with the rubber matrix in order to provide chemical and heat resistance. The adhesive compositions may also exhibit desirable adhesion or bonding strength, elasticity, elastic recovery, and/or surface tack.

Accordingly, the adhesive compositions may be used to form any article, such as an adhesive film or webbing that requires similar or improved chemical resistance and heat resistance as compared to conventional thermoplastic polyurethane compositions. The adhesive compositions are especially useful in seamless construction of performance apparel and sportswear, which may be subjected to deodorant, sweat, body oils, and other chemicals, and may routinely undergo heating during washing and drying.

The adhesive compositions described herein may generally be described as comprising a styrene-ethylene/butylene-styrene triblock copolymer, a tackifier, a white mineral oil, and an incompatible polymer composition comprising at least two of a high density polyethylene, a crosslinked ethylene-propylene-diene rubber, and an olefin block copolymer.

### Styrene-Ethylene/Butylene-Styrene Triblock Copolymer

The adhesive compositions disclosed herein comprise a styrene-ethylene/butylene-styrene triblock copolymer. The styrene-ethylene/butylene-styrene triblock copolymer is included to impart adhesion, elasticity, and surface tack to the adhesive compositions.

In embodiments, the adhesive composition may comprise a minimum amount of the styrene-ethylene/butylene-styrene triblock copolymer (e.g., greater than or equal to 18 wt %) such that the adhesive composition has a minimum melt flow rate (e.g., greater than or equal to 7 grams per 10 minute (g/10 min), as measured at 190 degrees Celsius (° C.) under a 2.16 kilogram (kg), load) suitable for forming a film and such that adhesion, elasticity, and surface tack are imparted to the adhesive composition. The amount of the styrene-ethylene/butylene-styrene triblock copolymer may be limited (e.g., less than or equal to 30 wt %) to achieve a desired elasticity and to maintain the melt flow rate below a certain threshold (e.g., less than or equal to 60 g/10 min, as measured at 190° C. under a 2.16 kg load) such that the adhesive composition may be processed into a film. Accordingly, in embodiments, the adhesive composition may comprise, based on a total weight of the adhesive composition, 18 wt % to 30 wt % of the styrene-ethylene/butylene-styrene triblock copolymer. In embodiments, the amount of the styrene-ethylene/butylene-styrene triblock copolymer in the adhesive composition may be, based on a total weight of the adhesive composition, greater than or equal to 18 wt %, greater than or equal to 20 wt %, or even greater than or equal to 22 wt %. In embodiments, the amount of the styrene-ethylene/butylene-styrene triblock copolymer in the adhesive composition may be, based on a total weight of the adhesive composition, less than or equal to 30 wt %, less than or equal to 28 wt %, or even less than or equal to 26 wt %. In embodiments, the amount of the styrene-ethylene/butylene triblock copolymer in the adhesive composition may be, based on a total weight of the adhesive composition, from 18 wt % to 30 wt %, from 18 wt % to 28 wt %, from 18 wt % to 26 wt %, from 20 wt % to 30 wt %, from 20 wt % to 28 wt %, from 20 wt % to 26 wt %, from 22 wt % to 30 wt %, from 22 wt % to 28 wt %, or even from 22 wt % to 26 wt %, or any and all sub-ranges formed from any of these endpoints.

The amount of styrene-ethylene/butylene-styrene triblock copolymer included in the adhesive composition may depend on the weight average molecular weight of the styrene-ethylene/butylene-styrene triblock copolymer. As the weight average molecular weight of the styrene-ethylene/butylene-styrene triblock copolymer increases, the amount of styrene-ethylene/butylene-styrene triblock copolymer in the adhesive composition may be adjusted accordingly. For example, if a styrene-ethylene/butylene-styrene triblock copolymer with a weight average molecular weight of 140,000 g/mol is used, then a relatively lower weight percentage, such as about 18 wt % of the styrene-ethylene/butylene-styrene triblock copolymer based on the total weight of the adhesive composition, may be included to achieve the desired properties. As another example, if a styrene-ethylene/butylene-styrene triblock copolymer with a weight average molecular weight of 90,000 g/mol is used, then a relatively higher weight percentage, such as near 30% of a styrene-ethylene/butylene-styrene triblock copolymer, based on the total weight of the adhesive composition, may be included to achieve the desired properties.

In embodiments, the styrene-ethylene/butylene-styrene triblock copolymer may have a minimum weight average molecular weight (e.g., greater than or equal to 90,000 grams per mole (g/mol)) to impart elastic recovery to the adhesive composition. The weight average molecular weight of the styrene-ethylene/butylene-styrene triblock copolymer may be limited (e.g., less than or equal to 140,000 g/mol) to allow the adhesive composition to be made into a film or webbing. Accordingly, in embodiments, the styrene-ethylene/butylene-styrene triblock copolymer may have a weight average molecular weight of 90,000 g/mol to 140,000 g/mol.

In embodiments, the styrene-ethylene/butylene-styrene triblock copolymer may have a minimum bound styrene content (e.g., greater than or equal to 20 wt % based on a total weight of the styrene-ethylene/butylene-styrene triblock copolymer) such that the styrene-ethylene-butylene-styrene separates into distinct rubbery and plastic phases in the adhesive composition. The weight percent of bound styrene content may be limited (e.g., less than or equal to 35 wt % based on a total weight of the styrene-ethylene/butylene-styrene triblock copolymer) so that there is a balance of elastic phase and plastic phase in the adhesive composition in order to develop elastic recovery. Accordingly, in embodiments, the styrene-ethylene/butylene-styrene triblock copolymer may have a bound styrene content of 20 wt % to 35 wt %, based on the total weight of the styrene-ethylene/butylene-styrene triblock copolymer. In embodiments, the bound styrene content of the styrene-ethylene/butylene-styrene triblock copolymer may, based on the total weight of the styrene-ethylene/butylene-styrene triblock copolymer, greater than or equal to 20 wt %, greater than or equal to 27 wt %, or even greater than or equal to 30 wt %. In embodiments, the bound styrene content of the styrene-ethylene/butylene-styrene triblock copolymer may be, based on the total weight of the styrene-ethylene/butylene-styrene triblock copolymer, less than or equal to 35 wt %, less than or equal to 33 wt %, or even less than or equal to 30 wt %. In embodiments, the bound styrene content of the styrene-ethylene/butylene triblock copolymer may be, based on a total weight of the styrene-ethylene/butylene-styrene triblock copolymer, from 20 wt % to 35 wt %, from 20 wt % to 33 wt %, from 20 wt % to 30 wt %, from 27 wt % to 35 wt %, from 27 wt % to 33 wt %, from 27 wt % to 30 wt %, from 30 wt % to 35 wt %, or even from 30 wt % to 33 wt %, or any and all sub-ranges formed from any of these endpoints.

In embodiments, the styrene-ethylene/butylene-styrene triblock copolymer may have a polydispersity from 1.0 to 3.0 such that the adhesive composition is able to flow so that it may be made into a film or webbing. In embodiments, the polydispersity of the styrene-ethylene/butylene-styrene triblock copolymer may be greater than or equal to 1.0, greater than or equal to 1.1, or even greater than or equal to 1.2. In embodiments, the polydispersity of the styrene-ethylene/butylene-styrene triblock copolymer may be less than or equal to 1.3, less than or equal to 1.2, or even less than or equal to 1.1. In embodiments, the polydispersity of the styrene-ethylene/butylene-styrene triblock copolymer may be from 1.0 to 1.3, from 1.0 to 1.2, from 1.0 to 1.1, from 1.1 to 1.3, from 1.1 to 1.2, or even from 1.2 to 1.3, or any and all sub-ranges formed from any of these endpoints.

Suitable styrene-ethylene/butylene-styrene triblock copolymers are available under the KRATON brand from Kraton, such as grades G1651 and G1650.

### Tackifier

The adhesive compositions disclosed herein comprise a tackifier. The tackifier is included in the adhesive composition to impart adhesion and surface tack.

In embodiments, the adhesive composition may comprise a minimum amount of the tackifier (e.g., greater than or equal to 6 wt % based on a total weight of the adhesive composition) to ensure adhesion is imparted to the adhesive composition. The amount of the tackifier may be limited (e.g., less than or equal to 30 wt % based on a total weight of the adhesive composition) to ensure that the adhesion is below a certain threshold to allow for processing in equipment and handling. Accordingly, in embodiments, the adhesive composition may comprise, based on a total weight of the adhesive composition, 6 wt % to 30 wt % of the tackifier. In embodiments, the amount of the tackifier may be, based on a total weight of the adhesive composition, greater than or equal to 6 wt %, greater than or equal to 7 wt %, or even greater than or equal to 8 wt %. In embodiments, the amount of the tackifier in the adhesive composition may be, based on a total weight of the adhesive composition, less than or equal to 30 wt %, less than or equal to 20 wt %, or even less than or equal to 10 wt %. In embodiments, the amount of the tackifier in the adhesive composition may be, based on a total weight of the adhesive composition, from 6 wt % to 30 wt %, from 6 wt % to 20 wt %, from 6 wt % to 10 wt %, from 7 wt % to 30 wt %, from 7 wt % to 20 wt %, from 7 wt % to 10 wt %, from 8 wt % to 30 wt %, from 8 wt % to 20 wt %, or even from 8 wt % to 10 wt %, or any and all sub-ranges formed from any of these endpoints.

In embodiments, the tackifier may comprise a minimum weight average molecular weight (e.g., greater than or equal to 500 g/mol) to maintain viscosity below a certain threshold such that it may be made into a film or webbing. The weight average molecular weight of the tackifier may be limited (e.g., less than or equal to 5000 g/mol) so that the tackifier is able to disperse in the adhesive composition and associate with the other compounds in the adhesive composition. Accordingly, in embodiments, the tackifier may comprise have a weight average molecular weight in the range of 500 g/mol to 5000 g/mol. In embodiments, the tackifier in the adhesive composition may comprise a weight average molecular weight of greater than or equal to 500 g/mol, greater than or equal to 1000 g/mol, or even greater than or equal to 2000 g/mol. In embodiments, the tackifier in the adhesive composition may comprise a weight average molecular weight of less than or equal to 5000 g/mol, less than or equal to 4000 g/mol, or even less than or equal to 3000 g/mol. In embodiments, the amount of the tackifier in the adhesive composition may comprise a weight average molecular weight from 500 g/mol to 5000 g/mol, from 500 g/mol to 4000 g/mol, from 500 g/mol to 3000 g/mol, from 1000 g/mol to 5000 g/mol, from 1000 g/mol to 4000 g/mol, from 1000 g/mol to 3000 g/mol, from 2000 g/mol to 5000 g/mol, from 2000 g/mol to 4000 g/mol, or even from 2000 g/mol to 3000 g/mol, or any and all sub-ranges formed from any of these endpoints.

In embodiments, the tackifier may comprise a minimum glass transition temperature (e.g., greater than or equal to 50° C.) such that the adhesive film composition does not soften at the temperature of the environment or at the body temperature of the wearer. The glass transition temperature of the tackifier may be limited (e.g., less than or equal to 100° C.) so that the adhesive composition is able to flow at the temperature at which a film or webbing comprising the adhesive composition is bonded to a fabric. Accordingly, in embodiments, the tackifier may comprise a glass transition temperature from 50° C. to 100° C. In embodiments, the tackifier in the adhesive composition may comprise a glass transition temperature greater than or equal to 50° C., greater than or equal to 60° C., or even greater than or equal to 75° C. In embodiments, the tackifier may comprise a glass transition temperature less than or equal to 100° C., less than or equal to 90° C., or even less than or equal to 80° C. In embodiments, the tackifier in the adhesive composition may comprise a glass transition temperature from 50° C. to 100° C., from 50° C. to 90° C., from 50° C. to 80° C., from 60° C. to 100° C., from 60° C. to 90° C., from 60° C. to 80° C., from 75° C. to 100° C., from 75° C. to 90° C., or even from 75° C. to 80° C., or any and all sub-ranges formed from any of these endpoints.

In embodiments, the tackifier may comprise a minimum softening temperature (e.g., greater than or equal to 100° C.) so that the adhesive composition is able to flow at the temperature at which a film or webbing comprising the adhesive composition is bonded to a fabric. The softening temperature of the tackifier may be limited (e.g., less than or equal to 140° C.) so that a film or webbing comprising the adhesive composition melts and flows at the temperature at which the film or webbing is bonded to a fabric. Accordingly, in embodiments, the tackifier may comprise a softening temperature from 100° C. to 140° C. In embodiments, the tackifier in the adhesive composition may comprise a softening temperature greater than or equal to 100° C., greater than or equal to 110° C., or even greater than or equal to 120° C. In embodiments, the tackifier may comprise a softening temperature less than or equal to 140° C., less than or equal to 135° C., or even less than or equal to 125° C. In embodiments, the tackifier in the adhesive composition may comprise a softening temperature from 100° C. to 140° C., from 100° C. to 135° C., from 100° C. to 125° C., from 110° C. to 140° C., from 110° C. to 135° C., from 110° C. to 125° C., from 120° C. to 140° C., from 120° C. to 135° C., or even from 120° C. to 135° C., or any and all sub-ranges formed from any of these endpoints.

The glass transition temperature and the softening temperature of the tackifier may vary based on the weight average molecular weight of the tackifier. Thus, the weight average molecular weight of the tackifier may be selected based on the desired glass transition temperature and softening temperature. As the weight average molecular weight increases, the glass transition temperature and the softening temperature will also increase. The softening temperature is the temperature at which the tackifier will bond with fabric to form a seam. For example, if bonding of the adhesive composition to fabric is desired at a temperature of 100° C., then a tackifier with a weight average molecular weight near 500 g/mol may be selected. As another example, if bonding of the adhesive composition to fabric is desired at a temperature of 140° C., then a tackifier with a weight average molecular weight near 5000 g/mol may be selected.

Suitable tackifiers are commercially available under the brand name PLASTOLYN from Synthomer, such as grade 290.

### White Mineral Oil

The adhesive compositions disclosed herein comprise a white mineral oil. The white mineral oil is included in the adhesive composition to impart processability to the adhesive composition to, for example, allow the adhesive composition to be extruded so that it can be made into a film or a webbing.

In embodiments, the adhesive composition may comprise a minimum amount of the white mineral oil (e.g., greater than or equal to 30 wt %) to ensure that the adhesive composition has a limited melt flow rate (e.g., less than or equal to 60 g/10 min, as measured at 190° C. under a 2.16 kg load) suitable for forming a film. The amount of the white mineral oil may be limited (e.g., less than or equal to 50 wt %) to maintain the melt flow rate above a certain threshold (e.g., greater than or equal to 6 g/10 min, as measured at 190° C. under a 2.16 kg load) such that the adhesive composition may be processed into a film. Accordingly, in embodiments, the adhesive composition may comprise, based on a total weight of the adhesive composition, 30 wt % to 50 wt % of the white mineral oil. In embodiments, the amount of the white mineral oil may be, based on a total weight of the adhesive composition, greater than or equal to 30 wt %, greater than or equal to 35 wt %, or even greater than or equal to 37 wt %. In embodiments, the amount of the white mineral oil in the adhesive composition may be, based on a total weight of the adhesive composition, less than or equal to 50 wt %, less than or equal to 45 wt %, or even less than or equal to 40 wt %. In embodiments, the amount of the white mineral oil in the adhesive composition may be, based on a total weight of the adhesive composition, from 30 wt % to 50 wt %, from 30 wt % to 45 wt %, from 30 wt % to 40 wt %, from 35 wt % to 50 wt %, from 35 wt % to 45 wt %, from 35 wt % to 40 wt %, from 37 wt % to 50 wt %, from 37 wt % to 45 wt %, or even from 37 wt % to 40 wt %, or any and all sub-ranges formed from any of these endpoints.

Suitable white mineral oil are commercially available under the brand name HYDROBRITE Sonneborn, such as grades 380, 100, and 550.

### Incompatible Polymer Composition

The adhesive compositions disclosed herein comprise an incompatible polymer composition. The incompatible polymer composition comprises at least two of a high density polyethylene, a crosslinked ethylene-propylene-diene rubber, and an olefin block copolymer. The incompatible polymer composition is included in the adhesive composition to impart chemical resistance and heat resistance.

In embodiments, the adhesive composition may comprise a minimum amount of the incompatible polymer composition (e.g., greater than or equal to 5 wt %) to ensure that chemical resistance and heat resistance are imparted to the adhesive composition. The amount of the incompatible polymer composition may be limited (e.g., less than or equal to 35 wt %) to ensure that the adhesive composition has a limited melt flow rate (e.g., less than or equal to 60 g/10 min, as measured at 190° C. under a 2.16 kg load) suitable for forming a film. Accordingly, in embodiments, the adhesive composition may comprise, based on a total weight of the adhesive composition, 5 wt % to 35 wt % of the incompatible polymer composition. In embodiments, the amount of the incompatible polymer composition may be, based on a total weight of the adhesive composition, greater than or equal to 5 wt %, greater than or equal to 10 wt %, or even greater than or equal to 20 wt %. In embodiments, the amount of the incompatible polymer composition in the adhesive composition may be, based on a total weight of the adhesive composition, less than or equal to 35 wt %, less than or equal to 30 wt %, or even less than or equal to 25 wt %. In embodiments, the amount of the incompatible polymer composition in the adhesive composition may be, based on a total weight of the adhesive composition, from 5 wt % to 35 wt %, from 5 wt % to 30 wt %, from 5 wt % to 25 wt %, from 10 wt % to 35 wt %, from 10 wt % to 30 wt %, from 10 wt % to 25 wt %, from 20 wt % to 35 wt %, from 20 wt % to 30 wt %, or even from 20 wt % to 25 wt %, or any and all sub-ranges formed from any of these endpoints.

Individually, the high density polyethylene, the crosslinked ethylene-propylene-diene rubber, and the olefin block copolymer of the incompatible polymer composition each may impart improved chemical resistance to the adhesive composition when added individually. However, when at least two of a high density polyethylene, a crosslinked ethylene-propylene-diene rubber, and an olefin block copolymer are added to the adhesive composition, the two components create a tortuous path for any chemical that is introduced to the overall composition. Without being bound by theory, it is believed that each of the high density polyethylene, the crosslinked ethylene-propylene-diene rubber, and the olefin block copolymer may be in their own polymer domains, which may confer the improved chemical resistance. Additionally, when at least two of a high density polyethylene, a crosslinked ethylene-propylene-diene rubber, and an olefin block copolymer are added to the adhesive composition, the at least two components create improved heat resistance.

### High Density Polyethylene

The incompatible polymer composition described herein may comprise a high density polyethylene. When combined with either a crosslinked ethylene-propylene-diene rubber, an olefin block copolymer of the incompatible polymer composition, or combinations thereof, the high density polyethylene improves the chemical resistance and the heat resistance of the adhesive composition, as described above.

In embodiments, the incompatible polymer composition may comprise a minimum amount of the high density polyethylene (e.g., greater than 0 wt %) to impart chemical resistance and temperature resistance to the adhesive composition. The amount of the high density polyethylene may be limited (e.g., less than or equal to 15 wt %) to ensure that high density polyethylene does not negatively interfere with the adhesive and elastic properties of a film or webbing comprising the adhesive composition. Accordingly, in embodiments, the incompatible polymer composition may comprise, based on a total weight of the adhesive composition, greater than 0 wt % to 15 wt % of the high density polyethylene. In embodiments, the amount of the high density polyethylene may be, based on a total weight of the adhesive composition, greater than or equal to 0 wt %, greater than or equal to 5 wt %, or even greater than or equal to 7 wt %. In embodiments, the amount of the high density polyethylene in the incompatible polymer composition may be, based on a total weight of the adhesive composition, less than or equal to 15 wt %, less than or equal to 13 wt %, or even less than or equal to 10 wt %. In embodiments, the amount of the high density polyethylene in the adhesive composition may be, based on a total weight of the adhesive composition, from 0 wt % to 15 wt %, from 0 wt % to 13 wt %, from 0 wt % to 10 wt %, from 5 wt % to 15 wt %, from 5 wt % to 13 wt %, from 5 wt % to 10 wt %, from 7 wt % to 15 wt %, from 7 wt % to 13 wt %, or even from 7 wt % to 10 wt %, or any and all sub-ranges formed from any of these endpoints.

In embodiments, the high density polyethylene may comprise a melt flow rate from 0.01 g/10 min to 100 g/10 min, as measured at 190° C. under a 2.16 kg load, such that the adhesive composition may be processed into a film. In embodiments, the melt flow rate of the high density polyethylene may be greater than or equal to 0.01 g/10 min, greater than or equal to 0.05 g/10 min, or even greater than or equal to 0.1 g/10 min, as measured at 190° C. under a 2.16 kg load. In embodiments, the high density polyethylene may comprise a melt flow rate less than or equal to 100 g/10 min, less than or equal to 90 g/10 min, or even less than or equal to 75 g/10 min, as measured at 190° C. under a 2.16 kg load. In embodiments, the melt flow rate of the high density polyethylene may be, as measured at 190° C. under a 2.16 kg load, from 0.01 g/10 min to 100 g/10 min, from 0.01 g/10 min to 90 g/10 min, from 0.01 g/10 min to 75 g/10 min, from 0.05 g/10 min to 100 g/10 min, from 0.05 g/10 min to 90 g/10 min, from 0.05 g/10 min to 75 g/10 min, from 0.1 g/10 min to 100 g/10 min, from 0.1 g/10 min to 90 g/10 min, or even from 0.1 g/10 min to 75 g/10 min, or any and all sub-ranges formed from any of these endpoints.

Suitable high density polyethylene is commercially available under the brand name SCLAIR from NOVA Chemicals, such as grade 2714.

Alternatively, the high density polyethylene may be replaced with polystyrene, polyethylene, or combinations thereof. The polystyrene, polyethylene, or combinations thereof may have the same or similar properties as the high density polyethylene described herein. The polystyrene, polyethylene, or combinations thereof may be used in the same or similar amounts as the high density polyethylene described herein.

### Crosslinked Ethylene-Propylene-Diene Rubber

The incompatible polymer composition described herein may comprise a crosslinked ethylene-propylene-diene rubber. When combined with either a high density polyethylene, an olefin block copolymer of the incompatible polymer composition, or combinations thereof, the crosslinked ethylene-propylene-diene rubber improves the chemical resistance and the heat resistance of the adhesive composition, as described above.

In embodiments, the incompatible polymer composition may comprise a minimum amount of the crosslinked ethylene-propylene-diene rubber (e.g., greater than 0 wt %) to impart chemical resistance and temperature resistance to the adhesive composition. The amount of the crosslinked ethylene-propylene-diene rubber may be limited (e.g., less than or equal to 20 wt %) to ensure that crosslinked ethylene-propylene-diene rubber does not negatively interfere with the adhesive and elastic properties of a film or webbing comprising the adhesive composition. Accordingly, in embodiments, the incompatible polymer composition may comprise, based on a total weight of the adhesive composition, greater than 0 wt % to 20 wt % of the crosslinked ethylene-propylene-diene rubber. In embodiments, the amount of the crosslinked ethylene-propylene-diene rubber may be, based on a total weight of the adhesive composition, greater than or equal to 0 wt %, greater than or equal to 5 wt %, or even greater than or equal to 7 wt %. In embodiments, the amount of the crosslinked ethylene-propylene-diene rubber in the incompatible polymer composition may be, based on a total weight of the adhesive composition, less than or equal to 20 wt %, less than or equal to 15 wt %, or even less than or equal to 10 wt %. In embodiments, the amount of the crosslinked ethylene-propylene-diene rubber in the adhesive composition may be, based on a total weight of the adhesive composition, from 0 wt % to 20 wt %, from 0 wt % to 15 wt %, from 0 wt % to 10 wt %, from 5 wt % to 20 wt %, from 5 wt % to 15 wt %, from 5 wt % to 10 wt %, from 7 wt % to 20 wt %, from 7 wt % to 15 wt %, or even from 7 wt % to 10 wt %, or any and all sub-ranges formed from any of these endpoints.

In embodiments, the amount of ethylene in the crosslinked ethylene-propylene-diene rubber may comprise, based on the total weight of the crosslinked ethylene-propylene-diene rubber, from 35 wt % to 85 wt %, from 35 wt % to 80 wt %, from 35 wt % to 75 wt %, 40% to 85 wt %, from 40 wt % to 80 wt %, from 40 wt % to 75 wt %, from 45 wt % to 85 wt %, from 45 wt % to 80 wt %, or even from 45 wt % to 75 wt %, or any and all sub-ranges formed from any of these endpoints.

In embodiments, the amount of propylene in the crosslinked ethylene-propylene-diene rubber may comprise, based on the total weight of the crosslinked ethylene-propylene-diene rubber, from 10 wt % to 65 wt %, from 10 wt % to 60 wt %, from 10 wt % to 45 wt %, 20% to 65 wt %, from 20 wt % to 60 wt %, from 20 wt % to 45 wt %, from 30 wt % to 65 wt %, from 30 wt % to 60 wt %, or even from 30 wt % to 45 wt %, or any and all sub-ranges formed from any of these endpoints.

In embodiments, the amount of diene monomers in the crosslinked ethylene-propylene-diene rubber may comprise, based on the total weight of the crosslinked ethylene-propylene-diene rubber, from 2.5 wt % to 12 wt %, from 2.5 wt % to 10 wt %, from 2.5 wt % to 9 wt %, 3 wt % to 12 wt %, from 3 wt % to 10 wt %, from 3 wt % to 9 wt %, from 3.5 wt % to 12 wt %, from 3.5 wt % to 10 wt %, or even from 3.5 wt % to 9 wt %, or any and all sub-ranges formed from any of these endpoints.

In embodiments, the crosslinked ethylene-propylene-diene rubber may comprise a Shore hardness from 25A to 95A, from 25A to 90A, from 25A to 85A, from 30A to 95A, from 30A to 90A, from 30A to 85A, from 35A to 95A, from 35A to 90A, or even from 35A to 85A, or any and all sub-ranges formed from any of these endpoints.

Suitable crosslinked ethylene-propylene-diene rubber is commercially available under the brand name SANTOPRENE from Exxon Mobile, such as grade RC8001.

### Olefin Block Copolymer

The incompatible polymer composition described herein may comprise an olefin block copolymer. When combined with either a high density polyethylene or a crosslinked ethylene-propylene-diene rubber, or combinations thereof, the olefin block copolymer improves the chemical resistance and the heat resistance of the adhesive composition, as described above.

In embodiments, the incompatible polymer composition may comprise a minimum amount of the olefin block copolymer (e.g., greater than 0 wt %) such that the adhesive composition achieves a morphology in the form of discreet domains, with or without intertwined filaments, that result in a tortuous path that prevents chemicals from penetrating the film or webbing and attacking its stability. The amount of the olefin block copolymer may be limited (e.g., less than or equal to 15 wt %) to ensure that crosslinked ethylene-propylene-diene rubber does not negatively interfere with the adhesive and elastic properties of a film or webbing comprising the adhesive composition. Accordingly, in embodiments, the incompatible polymer composition may comprise, based on a total weight of the adhesive composition, greater than 0 wt % to 15 wt % of the olefin block copolymer. In embodiments, the amount of the olefin block copolymer may be, based on a total weight of the adhesive composition, greater than or equal to 0 wt %, greater than or equal to 5 wt %, or even greater than or equal to 10 wt %. In embodiments, the amount of the olefin block copolymer in the incompatible polymer composition may be, based on a total weight of the adhesive composition, less than or equal to 15 wt %, less than or equal to 14 wt %, or even less than or equal to 12 wt %. In embodiments, the amount of the high density polyethylene in the adhesive composition may be, based on a total weight of the adhesive composition, from 0 wt % to 15 wt %, from 0 wt % to 14 wt %, from 0 wt % to 12 wt %, from 5 wt % to 15 wt %, from 5 wt % to 14 wt %, from 5 wt % to 12 wt %, from 10 wt % to 15 wt %, from 10 wt % to 14 wt %, or even from 10 wt % to 12 wt %, or any and all sub-ranges formed from any of these endpoints.

In embodiments, the olefin block copolymer may comprise a Shore hardness from 25A to 95A, from 25A to 90A, from 25A to 85A, from 30A to 95A, from 30A to 90A, from 30A to 85A, from 35A to 95A, from 35A to 90A, or even from 35A to 85A, or any and all sub-ranges formed from any of these endpoints.

Suitable olefin block copolymer is commercially available under the brand name INFUSE from DOW Chemical, such as grade 9107.

### Other Additives

In embodiments, adhesive compositions as disclosed herein may further comprise one or more optional other additives.

Suitable other additives may include conventional or commercially available plastics additives. Those skilled in the art of thermoplastics compounding, without undue experimentation, may select suitable additives from available references, for example, E. W. Flick, “Plastics Additives Database,” Plastics Design Library (Elsevier 2004).

Optional other additives may be used in any amount that is sufficient to obtain a desired processing or performance property for the material or component formed therefrom. The amount should not be wasteful of the additive nor detrimental to the processing or performance of the material or article formed therefrom.

Non-limiting examples of optional other additives may include one or more of antioxidants; nucleating agents; colorants (e.g., pigments and/or dyes); inorganic mineral fillers; mineral oils, flame retardants; glass beads, glass flakes, and glass fibers; impact modifiers; micas; slip and anti-blocking agents; ultraviolet light absorbers; micas; and waxes. The inorganic mineral fillers, micas, and glass beads may contribute to chemical resistance. The antioxidants and UV stabilizers may contribute to the long term stability of the adhesive composition.

### Method of Preparing Adhesive Composition

In embodiments, a method of preparing an adhesive composition may comprise combining a styrene-ethylene/butylene-styrene triblock copolymer, a tackifier, a white mineral oil, and an incompatible polymer composition as disclosed herein using, for example, a single screw extruder or a twin screw extruder.

The extruder may be operated at a temperature from 125° C. to 450° C., from 125° C. to 400° C., from 125° C. to 375° C., from 180° C. to 450° C., from 180° C. to 400° C., from 180° C. to 375° C., from 200° C. to 450° C., from 200° C. to 400° C., or even from 200° C. to 375° C., or any and all sub-ranges formed from any of these endpoints.

The extruder may be operated at a shear rate from 100 s⁻¹ to 10000 s⁻¹, from 100 s⁻¹ to 5000 s⁻¹, from 100 s⁻¹ to 2500 s⁻¹, from 500 s⁻¹ to 10000 s⁻¹, from 500 s⁻¹ to 5000 s⁻¹, from 500 s⁻¹ to 2500 s⁻¹, from 1000 s⁻¹ to 10000 s⁻¹, from 1000 s⁻¹ to 5000 s⁻¹, or even from 1000 s⁻¹ to 2500 s⁻¹, or any and all sub-ranges formed from any of these endpoints.

Operating the extruder at the temperatures and shear rates disclosed herein may ensure the flow and homogenous mixing of the styrene-ethylene/butylene-styrene triblock copolymer, tackifier, white mineral oil, and incompatible polymer composition. Operating the extruder at the temperatures and shear rates disclosed herein may also help to achieve the morphology of discreet domains, with or without intertwined filaments, in the adhesive composition, leading to the desired chemical resistance and heat resistance.

In some embodiments, the adhesive composition may be pelletized after it is extruded.

### Adhesive Composition

As described herein, the adhesive composition may have a similar or improved chemical resistance and heat resistance as compared to conventional thermoplastic polyurethane compositions. The adhesive compositions may also exhibit desirable adhesion or bonding strength, elasticity, elastic recovery, and/or surface tack.

In embodiments, the adhesive composition may have a peel force greater than or equal to 700 newton per linear meter (N/m) or even 750 N/m to ensure sufficient bonding to various materials, such as nylon and polyester.

In embodiments, the adhesive composition may have a load at 200% from 750 kPa to 1100 kPa, from 800 kPa to 1100 kPa, from 750 kPa to 1000 kPa, from 800 kPa to 1000 kPa, from 750 kPa to 950 kPa, or even from 800 kPa to 950 kPa, or any and all sub-ranges formed from any of these endpoints, to ensure that the adhesive composition has sufficient elasticity such that the apparel including the adhesive composition is comfortable while remaining in place and on the body of the wearer.

In embodiments, the adhesive composition may have a percent hysteresis less than or equal to 30% less than or equal to 28%, less than or equal to 26%, less than or equal to 25%, less than or equal to 23%, less than or equal to 22%, or even less than or equal to 20% to ensure that the adhesive composition has sufficient elastic recovery. In embodiments, the adhesive composition may have a percent hysteresis in the range of 30% to 20%, in the range of 28% to 22%, or in the range of 26% to 23%.

In embodiments, the adhesive composition may have a melt index greater than or equal to 10 g/10 min, as measured according to ASTM D1238 at 210° C. and under 2.16 kg load, to ensure the adhesive composition has sufficient flow for processing, particularly to form a film. In embodiments, the adhesive composition may have a melt index from 10 g/10 min to 20 g/10 min, as measured according to ASTM D1238 at 210° C. and under 2.16 kg load.

In embodiments, the adhesive composition may have a surface tack such that the adhesive film composition may be manually handled with ease.

In embodiments, the adhesive composition may have a hardness greater than or equal to 30A or even greater than or equal to 40A. In embodiments, the adhesive composition may have a hardness less than or equal to 55A or even less than or equal to 45A. In embodiments, the adhesive composition may have a hardness from 30A to 55A, from 30A to 45A, from 40A to 55A, from 40A to 45A, or any and all sub-ranges formed from any of these endpoints.

As described herein, the adhesive compositions may be used to form any article, such as an adhesive film or webbing, that requires similar or improved chemical resistance and heat resistance as compared to conventional thermoplastic polyurethane compositions. The adhesive compositions are especially useful in seamless construction of performance apparel and sportswear, which may be subjected to deodorant, sweat, body oils, and other chemicals, and may routinely undergo heating during washing and drying.

### Method of Forming Adhesive Film

A method of forming a film may comprise preparing an adhesive film composition and extruding the adhesive film composition to form a film that has a thickness of 25 μm to 350 μm. The adhesive film composition may comprise an adhesive composition according to one or more of the embodiments described herein.

For example, the prepared adhesive film composition or components thereof may be fed into an extruder and melt-mixed at a temperature greater than or equal to the melting temperature of the adhesive composition. In embodiments, the adhesive composition may be melt be melt-mixed at a temperature from 150° C. and 240° C. and for a time from 10 seconds (sec) to 120 sec. In embodiments, the adhesive composition may be melt be melt-mixed at a temperature from 150° C. to 240° C., from 150° C. to 230° C., from 150° C. to 220° C., from 160° C. to 240° C., from 160° C. to 230° C., from 160° C. to 220° C., from 170° C. to 240° C., from 170° C. to 230° C., or even from 170° C. to 220° C., or any and all sub-ranges formed from any of these endpoints. In embodiments, the adhesive composition may be melt be melt-mixed for a time from 10 sec to 120 sec, from 10 sec to 90 sec, 10 sec to 60 sec, from 20 sec to 120 sec, from 20 sec to 90 sec, 20 sec to 60 sec, 30 sec to 120 sec, from 30 sec to 90 sec, or even from 30 sec to 60 sec, or any and all sub-ranges formed from any of these endpoints.

The adhesive film composition may be extruded from the extruder to form the film.

### Adhesive Film

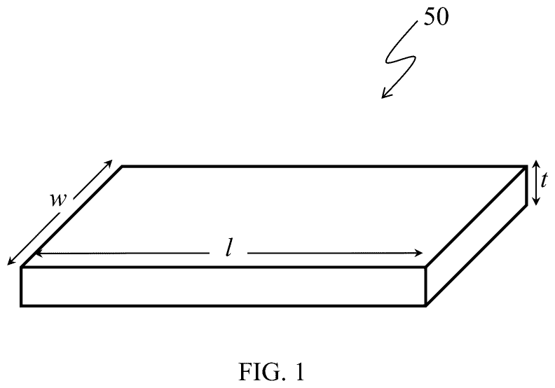

Referring now to FIG. 1, an adhesive film is shown at 50. The adhesive film 50 comprises a length l, a width w, and a thickness t. The adhesive film may comprise the adhesive composition according to one or more of the embodiments described herein.

In embodiments, the adhesive film 50 may have an appropriate thickness to provide minimal bulk in seamless construction and/or to achieve enhanced performance. For example, in embodiments, the adhesive film 50 may have a thickness t of 25 μm to 350. In some embodiments, the adhesive film 50 may have a thickness t greater than or equal to 25 μm, greater than or equal to 50 μm, or even greater than or equal to 100 μm. In embodiments, the adhesive film 50 may have a thickness t less than or equal to 350 μm, less than or equal to 300 μm, less than or equal to 250 μm less than or equal to 200 μm, or even less than or equal to 150 μm. In embodiments, the adhesive film 50 may have a thickness t from 25 μm to 350 μm, from 25 μm to 300 μm from 25 μm to 250 μm, from 25 μm to 200 μm, from 25 μm to 150 μm, from 50 μm to 350 μm, from 50 μm to 300 μm, from 50 μm to 250 μm, from 50 μm to 200 μm, from 50 μm to 250 μm, from 100 μm to 350 μm, from 100 μm to 300 μm, from 100 μm to 250 μm, from 100 μm to 200 μm, or even from 100 μm to 150 μm, or any and all sub-ranges formed from any of these endpoints. The thickness of the adhesive film 50 may be determined by measuring the adhesive film 50 thickness t with a thickness gauge.

In embodiments, the width w may be selected to conform to the width of the manufacturing equipment used to conform to the width of a fabric to which the adhesive film is to be applied. In embodiments, the width w may be further reduced after manufacturing by cutting or slitting the film. For example, in embodiments, the adhesive film 50 may have a width w from 5 cm to 40 cm. In embodiments, the adhesive film 50 may have a width w greater than or equal to 5 cm, greater than or equal to 10 cm, or even greater than or equal to 20 cm. In embodiments, the adhesive film may have a width w less than or equal to 40 cm or even less than or equal to 30 cm. In embodiments, the adhesive film may have a width w from 5 cm to 40 cm, from 5 cm to 30 cm, from 10 cm to 40 cm, from 10 cm to 30 cm, from 20 cm to 40 cm, from 20 cm to 30 cm, or any and all sub-ranges formed from any of these endpoints.

In embodiments the adhesive film 50 may be coated with a polymeric powder or dusting agent to ensure ease of manual handling. Examples of a suitable polymeric powders and dusting agents may include powdered polyethylene and powdered polypropylene.

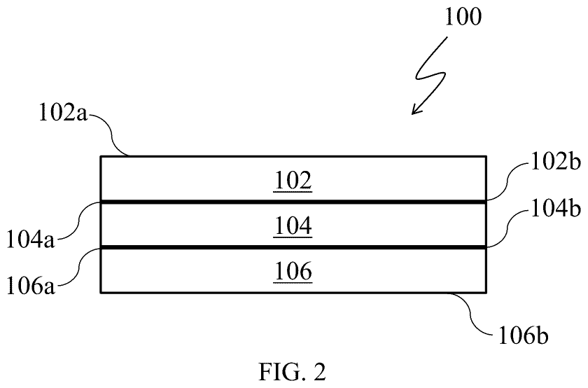

In some embodiments, the adhesive film may be part of a multilayer composite comprising two or more films. For example, referring now to FIG. 2, a multilayer composite is shown at 100. The multilayer composite 100 includes a first adhesive film 102, a second adhesive film 104, and a third adhesive film 106. Each of the first adhesive film 102, the second adhesive film 104, and the third adhesive film 106 have a first surface 102a, 104a, and 106a, respectively, and an opposing second surface 102b, 104b, and 106b, respectively. The opposing second surface 102b of the first adhesive film 102 may be bonded to the first surface 104a of the second adhesive film 104. The opposing second surface 104b of the second film 104 may be bonded to the first surface 106a of the third adhesive film 106.

At least one film in the multilayer composite may be an adhesive composition as described herein. In some embodiments, all of the films in the multilayer composite are adhesive films. In some embodiments, each film in the multilayer composite has the same composition as the other films in the multilayer composite. In some embodiments, each film in the multilayer composite has a different composition as the other films in the multilayer composite. In some embodiments, some of the films in the multilayer composite have the same compositions and some the films in the multilayer composition have different compositions.

In some embodiments, one or more films in the multilayer composite may enhance a specific property of the multilayer composite. For example, one or more layers of the multilayer composite may enhance the chemical resistance or surface tack of the multilayer composite. In some embodiments, the adhesive film may comprise one or more outer layers of the multilayer composite. In some embodiments, the adhesive film may provide chemical resistance that protects an inner film layer of the multilayer composite from chemical attack. In some embodiments, the inner layer of film may comprise a thickness greater than the thickness of the adhesive film. In some embodiments, the inner layer of film may impart elasticity and elastic recovery to the multilayer composite.

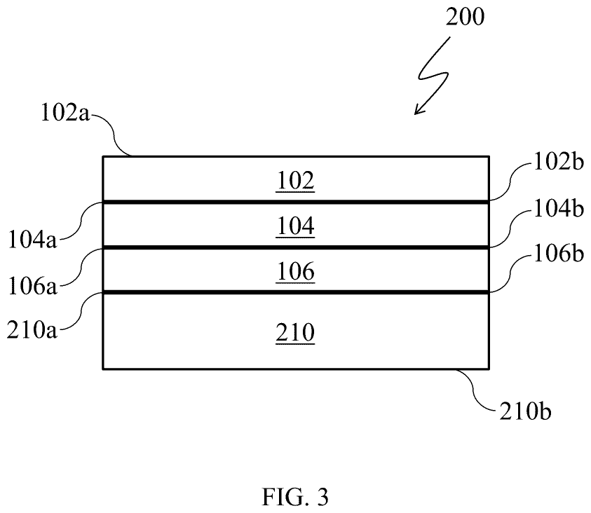

In some embodiments, the adhesive film may be part of a multilayer composite comprising the film adhered to a fabric backing. For example, referring now to FIG. 3, a multilayer composite with the adhesive film adhered to a fabric backing is shown at 200. The multilayer composite with the adhesive film adhered to a fabric backing 200 may include the first adhesive film 102, the second adhesive film 104, and the third adhesive film 106 as shown and described with respect to FIG. 2. The multilayer composite 200 further includes a fabric backing 210. The opposing second surface 106b of the third adhesive film 106 may be bonded to the first surface 210a of the fabric backing 210. The fabric back 210 may comprise nylon, polyester, acrylic, polyurethane, olefin, neoprene, acetate, elastane, or a combination thereof.

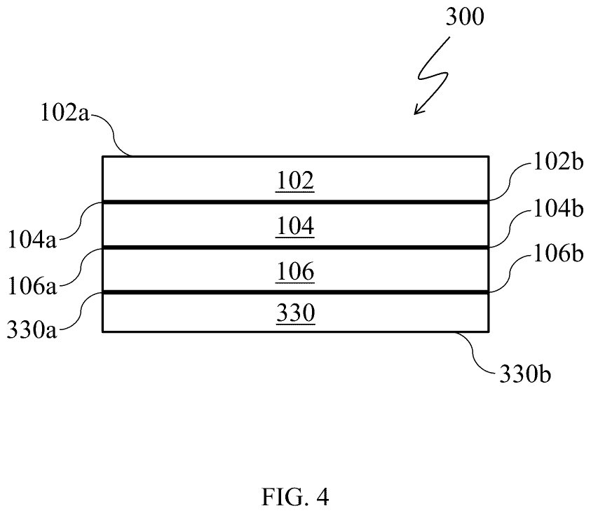

In some embodiments, the adhesive film may be part of a multilayer composite comprising the film adhered to a release liner. For example, referring now to FIG. 4, a multilayer composite comprising the adhesive film adhered to a release liner is shown at 300. The multilayer composite with the adhesive film adhered to a release liner 300 may include the first adhesive film 102, the second adhesive film 104, and the third adhesive film 106 as shown and described with respect to FIG. 2. The multilayer composite 300 further includes a release liner 330. The opposing second surface 106b of the third adhesive film 106 may be in contact with the first surface 330a of the release liner 330. In embodiments, the release liner 330 may comprise paper. The paper may be coated with a release material. The release material may decrease the force needed to remove the adhesive film from the release liner. The release material may comprise silicone.

In some embodiments, the release liner may be removable. In some embodiments, the multilayer composite comprising the adhesive film adhered to a release liner may comprise release liners on both surfaces of the multilayer composite. In some embodiments, the multilayer composite comprising the adhesive film adhered to a release liner may comprise a release liner on only one surface of the multilayer composite. In some embodiments, the release liner may be removed prior to using the multilayer composite.

In some embodiments, the adhesive film may be cut or slit to the desired width and then wound on a release liner as a roll. This roll may then be fed into an application machine and the application machine may then be used to apply the adhesive film onto fabric during apparel construction. The application machine may apply the adhesive film to fabric by unwinding the roll, bringing the adhesive film in to contact with the apparel, and removing and discarding the release liner.

### Method of Forming Adhesive Webbing

A method of forming an adhesive webbing may comprise preparing an adhesive webbing composition and extruding the adhesive composition to form a webbing that has a thickness of 25 μm to 350 μm. The adhesive webbing composition may comprise an adhesive composition according to one or more of the embodiments described herein

For example, the prepared adhesive webbing composition or components thereof may be fed into an extruder and melt-mixed at a temperature and for a time the same or similar to that described herein with respect to the method of forming an adhesive film.

The adhesive webbing composition may be extruded from the extruder.

As the adhesive composition is being extruded from the extruder, a die with multiple die holes at the end of the extruder may rotate and the adhesive composition may pass through these die holes as a filament on a traveling wire. The rotation of the die with multiple holes will cause the filaments to lay on top of each other and fuse together as a webbing.

### Adhesive Webbing

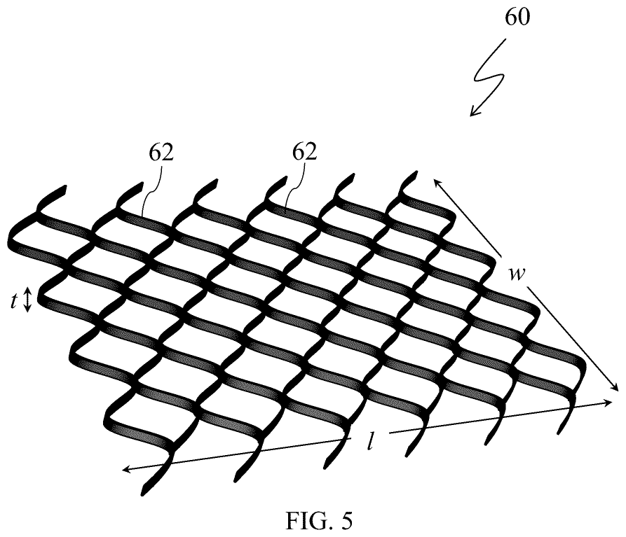

Referring now to FIG. 5, an adhesive webbing is shown at 60. The adhesive webbing 60 comprises a length l, a width w, and a thickness t. As shown in FIG. 5, adhesive webbing 60 comprise filaments 62 that may comprise the adhesive composition according to embodiments described and that are fused together to form the adhesive webbing 60. The adhesive webbing 60 may comprise the adhesive composition according to embodiments described herein.

The adhesive webbing 60 may have the same or similar thickness t and/or width w as described herein with respect to the adhesive film.

In embodiments, the use of an adhesive webbing may be desirable for applications where less fabric surface area needs to be bonded to an adhesive structure or applications where cost saving is desired.

In embodiments, similar to the adhesive film as described herein, the adhesive webbing 60 may be coated with a polymeric powder or dusting agent to ensure ease of manual handling. Examples of polymeric powders and dusting agents include powdered polyethylene and powdered polypropylene.

### Method of Preparing a Seam

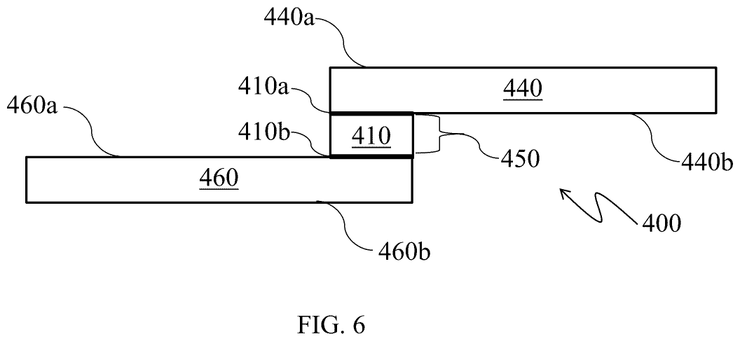

Referring now to FIG. 6, a method of preparing a seam comprises supplying a first section of fabric 440, a second section of fabric 460, and an adhesive layer 410; situating the adhesive layer 410 between the first section of fabric 440 and the second section of fabric 460 to form a seam section 450; and heating the seam section 450 such that the adhesive layer 410 adheres the first section of fabric 440 and the second section of fabric 460. As shown in FIG. 6, the second section of fabric 460 at least partially overlaps the first section of fabric 440. These steps may be performed in sequence. The adhesive layer 410 may comprise an adhesive composition according to one or more of the embodiments described herein. The adhesive layer 410 may be an adhesive film or an adhesive webbing.

Heating the seam section 450 may be performed using a hot iron or hot air. The seam section 450 may be heated to a temperature greater than or equal to 100° C., greater than or equal to 110° C., or even greater than or equal to 120° C. In embodiments, the seam section may be heated to a temperature less than or equal to 140° C. or even less than or equal to 130° C. In embodiments, the seam section may be heated to a temperature from 100° C. to 140° C., from 100° C. to 130° C., from 110° C. to 140° C., from 110° C. to 130° C., from 120° C. to 140° C., or even from 120° C. to 130° C., or any and all sub-ranges formed from any of these endpoints. In some embodiments, the seam section 450 may be heated to the softening temperature of the adhesive composition.

In embodiments, the seam section 450 may be compressed manually or by a compression machine. The seam section 450 may be compressed at a pressure of greater than or equal to 5 kilopascal (kPa), greater than or equal to 15 kPa, or even greater than or equal to 30 kPa. In embodiments, the seam section may be compressed at a pressure of less than or equal to 200 kPa, less than or equal to 100 kPa, or even less than or equal to 50 kPa. In embodiments, the seam section 450 may be heated to a temperature from 5 kPa to 200 kPa, from 5 kPa to 100 kPa, from 5 kPa to 50 kPa, from 15 kPa to 200 kPa, from 15 kPa to 100 kPa, from 15 kPa to 50 kPa, from 30 kPa to 200 kPa, from 30 kPa to 100 kPa, or even from 30 kPa to 50 kPa, or any and all sub-ranges formed from any of these endpoints.

### Seam

Referring again to FIG. 6, a seam is shown at 400. The seam 400 includes a first section of fabric 440, a second section of fabric 460, and an adhesive layer 410. The adhesive layer 410 comprises an adhesive film as described herein or an adhesive webbing as described herein. Each of the first section of fabric 440, the second section of fabric 460, and the adhesive layer 410 have a first surface 440a, 460a, and 410a, respectively, and an opposing second surface 440b, 460b, and 410b, respectively. At least a portion of the opposing second surface 440b of the first section of fabric 440 may be bonded to the first surface 410a of the adhesive layer 410. At least a portion of the first surface 460a of the second section of fabric 460 may be bonded to the opposing second surface 410b of the adhesive layer 410. The adhesive layer 410 is in the seam section 450. In embodiments, the adhesive layer 410 may be disposed between the first section of fabric 440 and the second section of fabric 460.

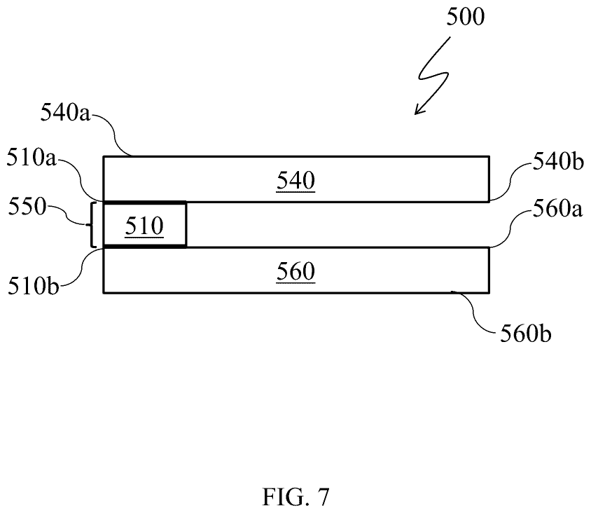

Referring now to FIG. 7, another seam is shown at 500, where the first section of fabric 540 fully overlaps the second section of fabric 560. The seam 500 includes a first section of fabric 540, a second section of fabric 560, and an adhesive layer 510. Each of the first section of fabric 540, the second section of fabric 560, and the adhesive layer 510 have a first surface 540a, 560a, and 510a, respectively, and an opposing second surface 540b, 560b, and 510b, respectively. At least a portion of the opposing second surface 540b of the first section of fabric 440 may be bonded to the first surface 510a of the adhesive layer 510. At least a portion of the first surface 560a of the second section of fabric 560 may be bonded to the opposing second surface 510b of the adhesive layer 510. The adhesive layer 510 is in the seam section 550. In embodiments, as shown in FIG. 7 the adhesive layer 510 may extend partially along the length of the first and second sections of fabric 540, 560. In other embodiments, the adhesive layer 510 may extend along the entire length of the first and second sections of fabric 540, 560.

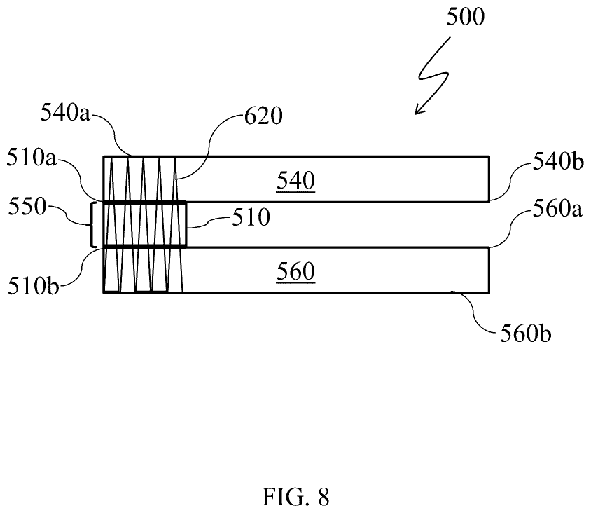

In some embodiments, the seam section may include stitches attaching the first section of fabric to the second section of fabric. For example, referring to FIG. 8, the seam section 550 may include stitches 620. In some embodiments, the seam section is a stitchless seam section, as shown in FIGS. 6 and 7.

The first and second sections of fabric of the seam may each comprise nylon, polyester, acrylic, polyurethane, olefin, neoprene, acetate, elastane, and combinations thereof. Examples of olefins include polypropylene polyethylene, and combinations thereof. Examples of neoprenes include polychloroprene. Examples of elastanes include spandex. Examples of spandex include Lycra®, commercially available from DOW Chemical. In some embodiments, the first section of fabric and the second section of fabric may have identical compositions. In some embodiments, the first section of fabric and the second section of fabric may have different compositions.

### EXAMPLES

Non-limiting examples of various embodiments of the disclosed invention are provided.

Table 1 below shows sources of ingredients of adhesive compositions used to form Example Adhesive Films E1 and E2.

TABLE 1

| Ingredients | Brand | Source |
|---|---|---|
| styrene-ethylene/butylene- | KRATON G1651 | Kraton |
| styrene triblock copolymer | | |
| styrene-ethylene/butylene- | KRATON G1650 | Kraton |
| styrene triblock copolymer | | |
| tackifier | PLASTOLYN 290 | Synthomer |
| white mineral oil | HYDROBRITE 380 | Sonneborn |
| high density polyethylene | SCLAIR 2714 | NOVA Chemicals |
| crosslinked ethylene-propylene- | SANTOPRENE | Exxon Mobile |
| diene rubber | RC8001 | |
| olefin block copolymer | INFUSE 9107 | DOW Chemical |
| thermoplastic polyurethane | — | — |
| (TPU) | | |

Example Adhesive Films E1 and E2 were prepared by first dry blending all raw materials except for HYDROBRITE 380 (white mineral oil). After being dry blended, the raw materials were then mixed with the HYDROBRITE 380. The mixture was then extruded using a twin screw extruder with temperature zones that started at a temperate of 150° C. and increased to 220° C. The extruded material, as it exited from the extruder, was pelletized using an underwater pelletizer.

Comparative Example Adhesive Film C1 was a thermoplastic polyurethane (TPU) webbing that was converted into a film using a compression molding machine.

Example Adhesive Films E1 and E2 and Comparative Example Adhesive Films C1 were situated between two layers of fabric and compressed at a pressure of 35 kPa for 30 seconds at 160° C. using a compression machine.

For the measurements, a cross section of Example Adhesive Films E1 and E2 and Comparative Example Adhesive Film C1 were taken to normalize for differences in the resulting film thickness.

Table 2 below shows the adhesive compositions used to form and the certain properties of Example Adhesive Films E1 and E2 and Comparative Example Adhesive Film C1.

TABLE 2

Example

| | E1 | E2 | C1 |
|---|---|---|---|
| Ingredient | Wt % | Wt % | Wt % |
| HYDROBRITE 380 | 40 | 37.50 | 0 |
| KRATON G1651 | 8 | 9 | 0 |
| SCLAIR 2714 | 10 | 8 | 0 |
| SANTOPRENE RC8001 | 8 | 9 | 0 |
| KRATON G1650 | 16 | 17 | 0 |
| PLASTOLYN 290 | 8 | 8 | 0 |
| INFUSE 9107 | 10 | 11.50 | 0 |
| TPU | 0 | 0 | 100 |
| TOTAL | 100 | 100 | 100 |
| Peel Force with 85 wt % polyester | 788 | 788 | 963 |
| and 15 wt % spandex fabric (N/m) | | | |
| Load at 200% (kPa) | 827 | 965 | 910 |
| Hysteresis (%) | 25 | 25 | 22 |
| Melt Index at 210° C. (g/10 min) | 13 | — | — |
| Hardness (Shore A) | 43A | 42A | 40A |

As exemplified in Table 2, the adhesive compositions disclosed herein may be used to form films having desirable adhesion or bonding strength, elasticity, and/or elastic recovery.

Table 3 below shows certain properties of Example Adhesive Films E1 and E2 and Comparative Example Adhesive Film C1. All of the films were placed between fabric comprising 85 wt % polyester and 15 wt % spandex. The films were bonded to the fabric at a bonding temperature of 160° C. for a time of 15 seconds. Wash cycles were conducted at 42° C. for 30 minutes. Dry cycles were conducted at approximately 30° C. for 25 minutes.

TABLE 3

| | | Example | | |
|---|---|---|---|---|
| | | E1 | E2 | C1 |
| | | Peel Force | Peel Force | Peel Force |
| Wash Condition | Deodorant Condition | (N/m) | (N/m) | (N/m) |
| Virgin laminate (no history of | No Deodorant | 701 | 928 | 701 |
| wash cycle or drying cycle) | | | | |
| One wash cycle followed by one | No Deodorant | 928 | 928 | 928 |
| drying cycle | | | | |
| One wash cycle followed by one | Deodorant applied for 8 hours on | 525 | 701 | 946 |
| drying cycle | both of the fabric layers that the | | | |
| | adhesive film was situated between | | | |
| | prior to the wash cycle | | | |
| Two wash cycles followed by a | Deodorant applied for 8 hours on | 438 | 928 | 928 |
| drying cycle after each wash | both of the fabric layers that the | | | |
| cycle | adhesive film was situated between | | | |
| | prior to each wash cycle | | | |
| Three wash cycles followed by a | Deodorant applied for 8 hours on | 525 | 438 | 438 |
| drying cycle after each wash | both of the fabric layers that the | | | |
| cycle | adhesive film was situated between | | | |
| | prior to each wash cycle | | | |

Referring to Table 3, Example Adhesive Films E1 and E2, adhesive films formed from adhesive compositions including KRATON G1651 and KRATON G1650 (styrene-ethylene/butylene-styrene triblock copolymer), PLASTOLYN 290 (tackifier), HYDROBRITE 380 (white mineral oil), SCLAIR 2714 (high density polyethylene), SANTOPRENE RC8001 (crosslinked ethylene-propylene-diene rubber), and INFUSE 9107 (olefin block copolymer), had similar peel force as compared to Comparative Example Adhesive Film C1, an adhesive film formed from an adhesive composition including thermoplastic polyurethane, after being subjected to various wash and deodorant conditions. As exemplified by Example Adhesive Films E1 and E2 and Comparative Example Adhesive Film C1, adhesive films formed from adhesive compositions as described herein have similar or improved chemical resistance and heat resistance as compared to conventional thermoplastic polyurethane compositions.

Every document cited herein is incorporated herein by reference in its entirety unless otherwise specified. The citation of any document is not to be construed as an admission that it is prior art with respect to any invention disclosed or claimed herein. To the extent that any meaning or definition of a term in this document conflicts with any meaning or definition of the same term in a document incorporated by reference, the meaning or definition assigned to that term in this document shall govern.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. An adhesive composition comprising, based on a total weight of the adhesive composition:
18 wt % to 30 wt % of a styrene-ethylene/butylene-styrene triblock copolymer, wherein the styrene-ethylene/butylene-styrene triblock copolymer has a weight average molecular weight of 90,000 g/mol to 140,000 g/mol;
6 wt % to 30 wt % of a tackifier, wherein the tackifier has a weight average molecular weight of 500 g/mol to 5000 g/mol, a glass transition temperature of 50° C. to 100° C., and a softening temperature of 100° C. to 140° C.;
30 wt % to 50 wt % of a white mineral oil; and
5 wt % to 35 wt % of an incompatible polymer composition, the incompatible polymer composition comprising at least two of a high density polyethylene, a crosslinked ethylene-propylene-diene rubber, and an olefin block copolymer.

2. The adhesive composition of claim 1, wherein the incompatible polymer composition comprises, based on the total weight of the adhesive composition, greater than 0 wt % to 15 wt % of the high density polyethelene.

3. The adhesive composition of claim 1, wherein the incompatible polymer composition comprises, based on the total weight of the adhesive composition, greater than 0 wt % to 20 wt % of the crosslinked ethylene-propylene-diene rubber.

4. The adhesive composition of claim 1, wherein the incompatible polymer composition comprises, based on the total weight of the adhesive composition, greater than 0 wt % to 15 wt % of the olefin block copolymer.

5. The adhesive composition of claim 1, wherein the adhesive composition has a melt index greater than or equal to 10 g/10 min, as measured according to ASTM D1238 at 210° C. and under 2.16 kg load.

6. The adhesive composition of claim 1, wherein the styrene-ethylene/butylene-styrene triblock copolymer has a bound styrene content of 20 wt % to 35 wt %, based on a total weight of the styrene-ethylene/butylene-styrene triblock copolymer.

7. The adhesive composition of claim 1, wherein the styrene-ethylene/butylene-styrene triblock copolymer has a polydispersity of 1.0 to 1.3.

8. The adhesive composition of claim 1, wherein the adhesive composition has a percent hysteresis less than or equal to 30%, as measured according to a two cycle 200% stretch test.

9. An adhesive webbing comprising the adhesive composition of claim 1.

10. An adhesive film comprising the adhesive composition of claim 1, wherein the adhesive film has a thickness of 25 μm to 350 μm.

11. The adhesive film of claim 10, wherein the adhesive film is part of a multilayer composite comprising two or more films.

12. The adhesive film of claim 10, wherein the adhesive film is part of a multilayer composite comprising the film adhered to a fabric backing.

13. The adhesive film of claim 10, wherein the adhesive film is part of a multilayer composite comprising the film adhered to a release liner.

14. The adhesive film of claim 10, wherein the adhesive film is coated with a polymeric powder or dusting agent.

15. The adhesive film of claim 10, wherein the adhesive film has a width of 5 cm to 40 cm.

16. A seam comprising:
a first section of fabric;
a second section of fabric at least partially overlapping the first section of fabric to form a seam section; and
an adhesive layer in the seam section adhering the first section of fabric to the second section of fabric, wherein the adhesive layer comprises an adhesive film or an adhesive webbing comprising the adhesive composition of claim 1.

17. The seam of claim 16, wherein the adhesive layer is disposed between the first section of fabric and the second section of fabric.

18. The seam of claim 16, wherein the seam section includes stitches attaching the first section of fabric to the second section of fabric.

19. The seam of claim 16, wherein the seam section is a stitchless seam section.

20. The seam of claim 16, wherein the first section of fabric and the second section of fabric each comprise nylon, polyester, acrylic, polyurethane, olefin, neoprene, acetate, elastane, or a combination thereof.

21. The seam of claim 16, wherein the adhesive layer is the adhesive film.

22. The seam of claim 16, wherein the adhesive layer is the adhesive webbing.

23. A method of preparing a seam comprising:
supplying a first section of fabric, a second section of fabric, and an adhesive layer;
situating the adhesive layer between the first section of fabric and the second section of fabric to form a seam section, wherein the second section of fabric at least partially overlaps the first section of fabric; and
heating the seam section such that the adhesive layer adheres the first section of fabric and the second section of fabric,
wherein the adhesive layer compromises an adhesive composition, the adhesive composition comprising, based on a total weight of the adhesive composition:
18 wt % to 30 wt % of a styrene-ethylene/butylene-styrene triblock copolymer, wherein the styrene-ethylene/butylene-styrene triblock copolymer has a weight average molecular weight of 90,000 g/mol to 140,000 g/mol;
6 wt % to 30 wt % of a tackifier, wherein the tackifier has a weight average molecular weight of 500 g/mol to 5000 g/mol, a glass transition temperature of 50° C. to 100° C., and a softening temperature of 100° C. to 140° C.;
30 wt % to 50 wt % of a white mineral oil; and
5 wt % to 35 wt % of an incompatible polymer composition, the incompatible polymer composition comprising at least two of a high density polyethylene, a crosslinked ethylene-propylene-diene rubber, and an olefin block copolymer.

24. The method of claim 23, wherein the incompatible polymer composition comprises, based on the total weight of the adhesive composition, greater than 0 wt % to 15 wt % of the high density polyethylene.

25. The method of claim 23, wherein the incompatible polymer composition comprises, based on the total weight of the adhesive composition, greater than 0 wt % to 20 wt % of the crosslinked ethylene-propylene-diene rubber.

26. The method of claim 23, wherein the incompatible polymer composition comprises, based on the total weight of the adhesive composition, greater than 0 wt % to 15 wt % of the olefin block copolymer.

27. The method of claim 23, where the step of heating the seam section is performed by a hot iron or hot air.

28. The method of claim 23, wherein the adhesive layer is an adhesive film.

29. The method of claim 23, wherein the adhesive layer is an adhesive webbing.
